(19) United States
(12) Patent Application Publication
(10) Pub. No.: US 2010/0102103 A1
(43) Pub. Date: Apr. 29, 2010

(54) Fuel-powered fastener driving device

(75) Inventors: Norbert Heeb, Buchs (CH); Tilo Dittrich, Feldkirch (AT)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/589,451

(22) Filed: Oct. 23, 2009

(30) Foreign Application Priority Data
Oct. 28, 2008 (DE) DE 102008043228.8

(51) Int. Cl. B25C 1/08

(52) U.S. Cl. 227/9

(57) ABSTRACT

A fuel-powered fastener driving device (10) for driving fastening elements, comprising a combustion chamber (15) for a fuel that can be metered using a metering means (21) and comprising an fuel-ignition means (26) arranged in the combustion chamber (15) is provided. Here, the ignition means has a resistance element that can be heated up by means of an ignition current in order to ignite an air-fuel mixture contained in the combustion chamber.

This claims priority to German Patent Application DE 10 2008 043 228.8, filed Oct. 28, 2008, the entire disclosure of which is hereby incorporated by reference herein.

The present invention relates to a fuel-powered fastener driving device for driving fastening elements.

### BACKGROUND OF THE INVENTION

Such fastener driving devices have a combustion chamber in which it is possible to burn a portion of liquefied gas or of another vaporizable fuel containing an oxidant such as, for instance, ambient air. The combustion energy powers a driving piston that is movably installed in a piston guide in order to drive a fastening element into an object.

U.S. Pat. No. 6,123,241 discloses a fuel-operated fastener driving device that has an electronic control unit to regulate the ignition and the fuel injection. The fastener driving device has an ignition means configured, for example, as a conventional spark plug.

A drawback of this solution is the fact that, on the one hand, the electronic unit for generating the high voltage is expensive and complex to manufacture and, on the other hand, strong electromagnetic radiation (EMI) is generated that can influence the electronic control unit and can lead to errors or malfunctions in the electric system of the fastener driving device. Processors, E-PROMS and/or memory units can be set into undefined states. Besides, in the case of the memory units, there is the risk that they could be overwritten or deleted. Furthermore, a frequent cause of malfunctions in such fuel-powered fastener driving devices is a short circuit between the electrodes of the spark plugs. In this context, the short circuit can be caused by a conductive layer of dirt that has built up, among other things, due to moisture from the combustion residues. Moreover, oil that is admixed as a lubricant to the fuel gas can accumulate on the electrodes and can form a bridge that prevents the formation of an ignition spark.

### SUMMARY OF THE INVENTION

It is an objective of the present invention to put forward a fuel-powered fastener driving device of the above-mentioned type that avoids these disadvantages, that is impervious to dirt, that ignites reliably and that can be manufactured inexpensively.

The present invention provides a fuel-operated fastener driving device for driving fastening elements, comprising a combustion chamber (15) for a fuel that can be metered using a metering means (21) and comprising a fuel-ignition means (26) arranged in the combustion chamber (15), characterized in that the ignition means (26) has a resistance element (36) in order to ignite the fuel. This resistance element is configured, for example, as a resistance wire or resistance track and, after the fastener driving device has been triggered, is supplied with current via a trigger switch, for example, by means of an electronic control unit, as a result of which said resistance element heats up and ignites the air-fuel mixture contained in the combustion chamber within approximately 10 to 100 ms after the triggering. In this process, the temperature of the resistance element reaches at least about 500° C. As an ignition-effective element of the ignition means, the resistance element also allows the use of an inexpensive and technically simple electronic control unit. Moreover, the ignition does not give rise to any electric malfunctions (EMI) that could cause errors in the electronic unit. Ignition is advantageously possible even if oil residues or other dirt has accumulated on the ignition means.

Advantageously, the resistance element is configured as a coiled filament, as a result of which a large contact surface area is available between the hot glow wire and the gas mixture that is to be ignited. Here, the relatively long wire can be accommodated in a relatively small space.

It is likewise advantageous for the resistance element to contain at least one metal of the group consisting of Cu, Ni, Wo, Cr, Mn, C, Si. Advantageously, the resistance element here consists of an alloy of one or more of these metals.

It is also advantageous for the resistance element to have an electric resistance of 0.5 to 10 ohm/mm².

Advantageously, the ignition current generated by an electronic control unit for the ignition means lies between 0.1 and 50 amperes.

### BRIEF DESCRIPTION OF THE DRAWINGS

The invention is depicted in the drawings on the basis of an embodiment.

The following is shown:

FIG. 1—a fuel-operated fastener driving device according to the invention, in a partial longitudinal section;

FIG. 2—a detail of the fuel-operated fastener driving device according to the marking II from FIG. 1.

### DETAILED DESCRIPTION

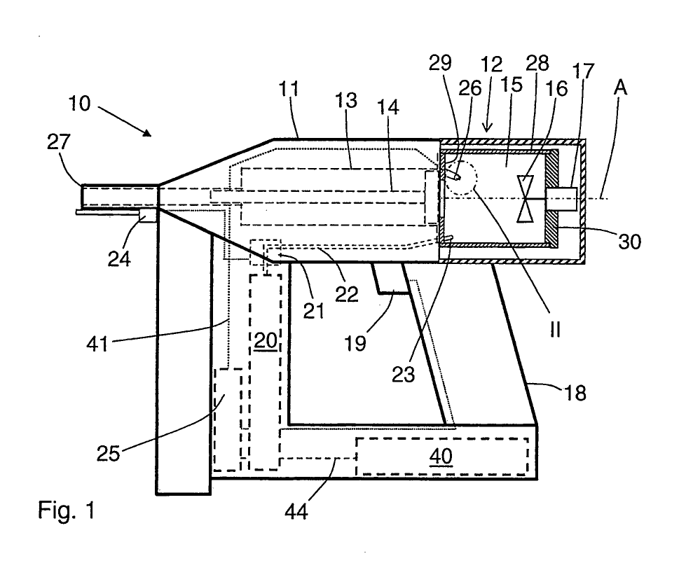

The hand-held, fuel-operated fastener driving device 10 according to FIG. 1 has a single-part or multiple-part housing—designated in its entirety by the reference numeral 11—in which there is a drive 12 that can be powered by an air-fuel mixture. The drive 12 serves to drive a fastening element such as a nail, bolt, etc. into a workpiece. The fastening elements can be stored, for example, in a cartridge on the fastener driving device 10.

The drive includes a combustion chamber 15 and a guide cylinder 13 in which a driving piston 14 is arranged so as to be axially movable. The combustion chamber 15 in the depicted initial state is delimited circumferentially by a combustion chamber sleeve 28 and axially on a first end by the driving piston 14 and by a ring-shaped combustion chamber wall 29, while on a second end, it is delimited by a combustion chamber rear wall 30 that is configured as a cylinder head.

A fan 16 that can be driven by a motor 17 and that is arranged in the combustion chamber 15 serves to generate a turbulent flow pattern for an air-fuel mixture contained in the closed combustion chamber 15 as well as to purge the opened combustion chamber 15 with fresh air once the driving procedure has been completed. Here, the motor 17 is mounted on the combustion chamber rear wall 30 that functions as a closure for the axially movable combustion chamber sleeve 28.

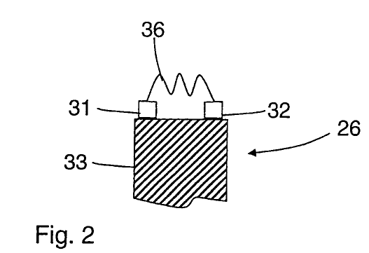

A trigger switch 19 is arranged on a handle 18 of the fastener driving device 10 and it serves to trigger an ignition means 26 arranged in the combustion chamber 15 by means of an electronic control unit 25 when the fastener driving device 10 is pressed against a workpiece, thereby activating a switch means 24 in the opening area 27 of the fastener driving device 10. For this purpose, the ignition means 26 is electrically connected to the electronic control unit 25 via a line 41. As can be seen in FIG. 2, the ignition means 26 has a resistance element 36 configured as a coiled filament and arranged between a first electrode 31 and a second electrode 32 of the ignition means 26, and the coiled filament can be heated up in order to ignite an air-fuel mixture in the combustion chamber via an ignition current supplied by the electronic control unit 25. The resistance element 36 here has an electric resistance of 0.5 to 10 ohm/mm² and contains a metal from the group consisting of Cu, Ni, Wo, Cr, Mn, C, Si. The electrodes 31, 32 are embedded in an insulating element 33 as the carrier element.

The fastener driving device 10 can be operated with a fuel gas or with a vaporizable liquefied fuel that is held in a fuel reservoir 20, for instance, a fuel can. The fuel reservoir 20 is connected to a fuel inlet 23 in the combustion chamber 15 via a fuel line 22. A metering means 21 such as, for example, a metering valve, is installed in the fuel line 22 and it serves to regulate the fuel feed to the combustion chamber 15.

In order to supply the electric consumers such as the ignition means and the motor 17 with electric power, there is also a source 40 of electric power, for instance, an accumulator.

The ignition means 26 and the metering means 21 are controlled electronically by means of an electronic control unit designated in its entirety by the reference numeral 25. The electronic control unit 25 has, for example, one or more microprocessors for the data processing and regulation of the various electric device functions and it is connected to the source 40 of electric power via an electric supply line 44. An ignition current generated by the electronic control unit 25 for the ignition means 26 preferably lies between 0.1 and 50 amperes.

What is claimed is:

1-5. (canceled)

6. A fuel-powered fastener driving device for driving fastening elements, comprising: a combustion chamber for a fuel that can be metered using a meter; and a fuel-igniter arranged in the combustion chamber, the igniter having a resistance element to ignite the fuel.

7. The fastener driving device according to claim 6, wherein the resistance element is configured as a coiled filament.

8. The fastener driving device according to claim 6, wherein the resistance element contains at least one metal of the group consisting of Cu, Ni, Wo, Cr, Mn, C, Si.

9. The fastener driving device according to claim 6, wherein the resistance element has an electric resistance of 0.5 to 10 ohm/mm².

10. The fastener driving device according to claim 6, wherein an ignition current generated by an electronic control unit for the igniter lies between 0.1 and 50 amperes.
